(19) United States
(12) Patent Application Publication
(10) Pub. No.: US 2015/0083227 A1
(43) Pub. Date: Mar. 26, 2015

(54) REDUCED FLUID DRAG ACROSS A SOLID SURFACE WITH A TEXTURED COATING

(71) Applicant: GENERAL ELECTRIC COMPANY, Schenectady, NY (US)

(72) Inventors: Rahul Anil BIDKAR, Niskayuna, NY (US); Ambarish Jayant KULKARNI, Glenville, NY (US); Luc Stephane LEBLANC, Clifton Park, NY (US); Vaibhav BAHADUR, Schenectady, NY (US)

(73) Assignee: GENERAL ELECTRIC COMPANY, Schenectady, NY (US)

(21) Appl. No.: 14/037,790

(22) Filed: Sep. 26, 2013

(51) Int. Cl. F15D 1/12; C23C 4/10; C23C 4/12

(52) U.S. Cl. CPC F15D 1/12; C23C 4/12; C23C 4/121; C23C 4/105
USPC 137/1; 428/141; 428/34.1; 428/36.91; 427/337; 427/446; 427/455; 427/453

(57) ABSTRACT

An article includes a substrate with a coating having asperities such that an average spacing between the asperities is between about 0.01 and about 1.5 micron. An average surface roughness of the coating is up to about 2 microns, and an average porosity of the coating is in the range from about 35% to about 70%. A material to reduce surface energy is disposed on the coating. A method for making such an article and a method for decreasing fluid drag across such an article are also provided.

### STATEMENT REGARDING FEDERALLY SPONSORED RESEARCH & DEVELOPMENT

This invention was made with Government support under contract number N00014-11-M-0044 awarded by the Office of Naval Research. The Government has certain rights to the invention.

### FIELD

The invention relates generally to methods for engineering a surface using textures and coatings to decrease fluid drag and systems for reducing fluid drag with surfaces that have such textures and coatings.

### BACKGROUND

Fluid drag at an interface between a solid surface and a liquid accounts for substantial resistance to the motion of the solid and liquid relative to each other, such as when the hull of a vessel travels through water or when a liquid flows through a pipe. Thus, there is a need for methods and systems for reducing drag at an interface between a liquid and a solid.

### SUMMARY

In one embodiment, an article is provided. The article includes a substrate; a coating disposed on the substrate having asperities such that an average spacing between asperities in between about 0.01 and about 1.5 micron, an average surface roughness of the coating is up to about 2 microns, and an average porosity of the coating is in the range from about 35% to about 60%; and a material to reduce surface energy is disposed on the coating.

In another embodiment, a method for decreasing fluid drag across a solid surface is provided. The method includes disposing a coating having asperities on a substrate, such that an average spacing between asperities is in the range of about 0.01 microns to about 1.5 micron, an average surface roughness of the coating is up to about 2 microns, and an average porosity of the coating is in the range from about 35% to 60%; and disposing on the coating a material to reduce surface energy.

In another embodiment, a method for decreasing fluid drag across a solid surface is provided. The method includes causing a fluid to flow over the surface of an article such that a local viscous sub-layer of the fluid is in contact with the surface; the article includes a coating having asperities disposed on a substrate, such that an average spacing between the asperities is in the range from about 0.01 micron to about 1.5 micron, an average surface roughness of the coating is up to about 10% of the thickness of the local viscous sub-layer, and an average porosity of the coating is in the range from about 35% to about 60%, and a material to reduce surface energy disposed on the coating; and the material to reduce surface energy is disposed to contact the fluid as the fluid flows over the surface of the article.

### DRAWINGS

These and other features, aspects, and advantages of the present invention will become better understood when the following detailed description is read with reference to the accompanying drawings, wherein:

FIGS. 1(A-B) are schematic figures showing a water drop on a solid surface and a water drop on a textured solid surface forming a Cassie state;

FIGS. 2(A-B) are schematic figures boundary layer and viscous sub-layer thicknesses relative to smooth and textured surfaces;

FIG. 3 is a scanning electron photomicrographic image of a cross-sectional view of a textured coating;

FIGS. 4(A-D) are scanning electron photomicrographic images at different magnifications of an elevation view of a textured coating which has been applied to a solid surface and upon which a layer of a fluorosilane has been applied in accordance with an aspect of the invention;

FIGS. 5(A-D) are scanning electron photomicrographic images at different magnifications of a cross-sectional view of a textured coating which has been applied to a solid surface and upon which a layer of a fluorosilane has been applied in accordance with an aspect of the invention;

FIGS. 6(A-D) are scanning electron photomicrographic images at different magnifications of an elevation view of a textured coating which has been applied to a solid surface and upon which a layer of polytetrafluoroethylene has been applied in accordance with an aspect of the invention;

FIGS. 7(A-D) are scanning electron photomicrographic images at different magnifications of a cross-sectional view of a textured coating which has been applied to a solid surface and upon which a layer of polytetrafluoroethylene has been applied in accordance with an aspect of the invention;

FIG. 8 is a line graph showing friction drag coefficients for water flow across solid surfaces, with or without textured coatings or a layer of surface energy modification material, under turbulent flow conditions, in accordance with an aspect of the invention;

FIG. 9 is a line graph showing the percent change in friction drag coefficients for water flow across solid surfaces with textured coatings and with layers of different surface energy modification materials deposited on the textured coatings, under turbulent flow conditions, in accordance with an aspect of the invention; and

FIG. 10 is a line graph showing friction drag coefficients for water flow across solid surfaces, with or without textured coatings or a layer of surface energy modification material, under turbulent flow conditions, in accordance with an aspect of the invention;

### DETAILED DESCRIPTION

The present invention includes a method of treating a solid surface so as to reduce fluid drag across it, a surface that has been so treated, and a method of decreasing fluid drag across such a surface. When a textured coating is applied to a solid surface and a material is applied to the textured coating to reduce surface energy as taught herein, substantial reductions in fluid drag are obtained, under conditions of both laminar and turbulent fluid flow.

Surprisingly, not all hydrophobic surfaces reduce drag across a wide range of laminar and turbulent fluid flow conditions and some hydrophobic surfaces actually increase fluid drag under certain circumstances. The present inventors have found that applying a textured coating with asperities that have a relatively low average spacing from one another, low roughness, and high porosity results in a decrease in fluid drag across the coated surface under both laminar and turbulent fluid flow conditions when a material that reduces surface energy is applied to the textured coating.

Embodiments of the present invention are directed to a method for reducing fluid drag across a solid surface by applying a textured coating to the surface and a material that reduces surface energy to the textured coating, a fluid drag-resistant solid surface that has such a textured coating to which a material for reducing surface energy has been applied, and a method for reducing fluid flow across a solid with such a textured coating and reduced surface energy.

In the following description and the claims that follow, whenever a particular aspect or feature of an embodiment of the invention is said to include, comprise, or consist of at least one element of a group and combinations thereof, it is understood that the aspect or feature may include, comprise, or consist of any of the elements of the group, either individually or in combination with any of the other elements of that group. Similarly, the singular forms “a”, “an” and “the” include plural referents unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about” may not be limited to the precise value specified, and may include values that differ from the specified value. In at least some instances, the approximating language may correspond to the precision of an instrument for measuring the value. In the present discussions it is to be understood that, unless explicitly stated otherwise, any range of numbers stated during a discussion of any region within, or physical characteristic of, is inclusive of the stated end points of the range.

When a solid surface and a liquid that are in contact with each other move in relation to one another, interactions at the interface between the solid and liquid create drag and impede movement of each relative to the other. Generally, there are two types of such drag, referred to as skin friction drag and form drag. In turn, reducing such drag effects may decrease the amount of energy required to move a fluid across a solid surface, or a solid surface through a fluid. For example, such a solid surface could be the inner surface of a pipe or the outer surface of a vessel hull, and the liquid could be water. As described below, increasing the hydrophobicity of a solid surface by giving it a textured coating and applying to the textured coating a material to reduce surface energy leads to decreased fluid drag across the surface under certain circumstances. A material to reduce surface energy may be a material with a lower surface energy than the textured coating to which it is applied.

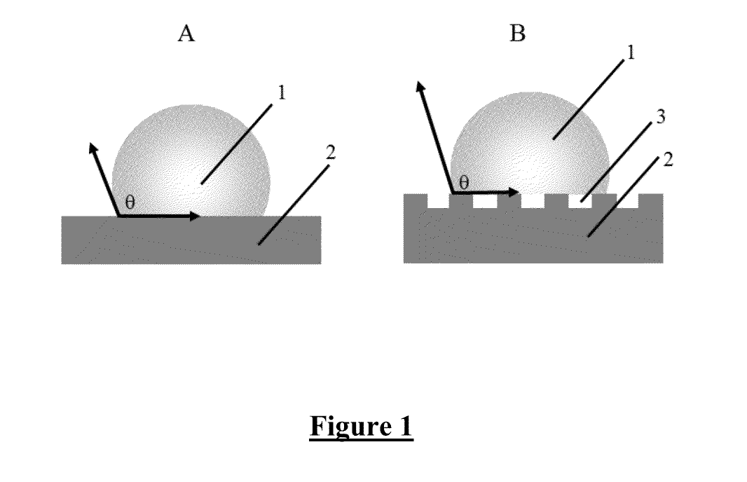

Hydrophobicity refers to whether water will tend to spread out across a surface upon which it is deposited, or to bead up into discrete droplets. For example as shown in FIG. 1A, a droplet of water 1 deposited on a surface 2 may bead up and, in extreme cases, form a nearly spherical droplet with minimal contact with the surface, rather than spread across the surface. A measure of hydrophobicity of a surface is given by the contact angle θ between a stationary droplet and a horizontal surface, such that a higher contact angle indicates higher hydrophobicity of that surface. It should be noted that the contact angle of a water droplet on a surface is the angle between the surface and the water-air interface, measured from inside the droplet. A surface is characterized as “hydrophobic” when it has a contact angle with water of about 90 degrees or more, and it is characterized as “super-hydrophobic” if it has a contact angle with water of above about 150 degrees.

In one example, by giving a solid surface a hydrophobic, porous textured coating with asperities whose average distance between each other is within a defined range, an average roughness that is within a defined range, and a porosity that is within a defined range, and then applying a material that reduces surface energy over the textured surface, fluid drag is significantly reduced. Surprisingly, merely increasing the hydrophobicity of a solid surface is not sufficient to reduce drag, in that the application of some hydrophobic textured surfaces actually increases fluid drag under some circumstances. In particular, as shown herein, a combination of relatively close spacing of asperities, relatively low roughness, and relatively high porosity of a textured coating leads to reduced fluid drag, across conditions that create both laminar and turbulent fluid flow, when a material that lowers surface energy has also been applied to the coating. Thus, whereas some hydrophobic and superhydrophobic surfaces in general may provide decreased fluid drag across some circumstances while others do not, the invention includes such surfaces with particular characteristics that impart especially robust anti-drag characteristics over a wide range of fluid flow conditions, and methods for their manufacture and use.

Reduced fluid drag results from minimizing the contact area at the interface between a liquid and a solid surface. One means of minimizing contact area is to create and maintain tiny pockets of trapped air at the interface, resulting in what is referred to as a Cassie state as depicted in FIG. 1B. When air is trapped in such pockets 3, contact between water 1 and solid surface 2 is reduced, such that there is less skin friction drag between the two upon relative movement. When a textured surface has closely spaced neighboring asperities and the surface chemistry of the asperities (or texture) is altered by applying a low surface energy material as a surface energy modification material, air may be retained in the spaces between the asperities despite destabilizing fluid pressures, thereby allowing for prolonged maintenance of a Cassie state and reduced fluid drag across a range of fluid flow conditions.

Specifically, the characteristic spacing (a) between asperities of the texture is related to fluid pressure (p), contact angle (θ) of fluid on the low surface energy material-covered coating, and surface energy (γ) of the liquid by the relation:

p=−4γ cos(θ)/a.

Under a given, known pressure (p) (such as pressure exerted by a known fluid flowing through a pipe or pressure on a vessel hull surface), certain surface chemistry can be chosen with specific values for surface energy (γ) and contact angle (θ), and the characteristic asperity spacing (a) can be calculated to promote stability of the Cassie state.

The presence of a Cassie state ensures that the contact between water and the solid surface is reduced compared to the water-solid contact area on a smooth, non-Cassie state surface. The wetted area fraction (f) for a textured surface represents the fraction of total surface area that is in contact with the water. For a textured surface with a low surface energy coating, the wetted area fraction is calculated as:

f=(1+cos(θ_{C}))/(1+cos(θ)),

where (θ) represents the contact angle measured for a liquid droplet on a smooth surface with the low surface energy coating, and (θ_{c}) represents the contact angle measured for a liquid droplet on a textured surface with the low surface energy coating. In some embodiments, a wetted area fraction of about 0.3 or smaller is desirable for fluid drag reduction using textured surfaces along with low surface-energy coatings.

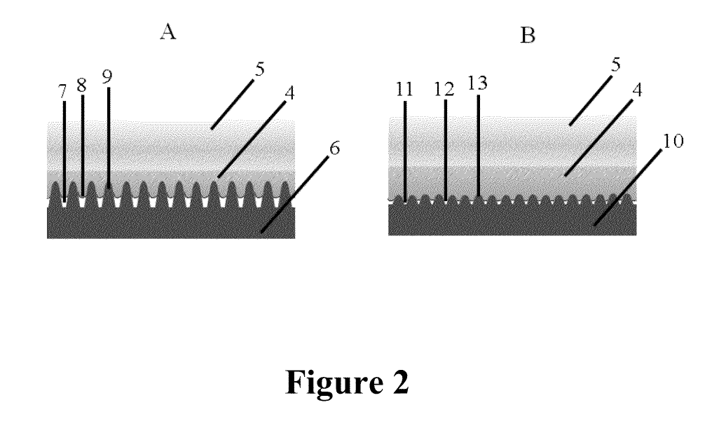

In addition to a sustained presence of Cassie state and a small wetted area fraction, average surface roughness of a surface plays an important role in reducing fluid drag. Surface roughness, as used herein, is defined as the arithmetic average of absolute variation of the measured surface profile from a mean line as calculated over an appropriate surface evaluation length (as defined in American Society of Mechanical Engineers (ASME) standard B46.1-2009). This roughness parameter is known in the art as Rₐ. As shown in FIG. 2A, roughening a surface 6 with texture allows the formation of miniscule texture peaks and valleys that promote the formation of air pockets 7. Air trapped in these pockets is bounded by the texture on the side of the solid and the water meniscus 8 on the side of the liquid. While a non-zero surface roughness is essential to form such air pockets 7 and reduce skin-friction fluid drag, excessive surface roughness may lead to excessive surface peak height 9 above the water meniscus 8, which in turn leads to increased fluid drag. The portion of individual texture peaks 9 that is above the water meniscus 8 and thereby in contact with water, gives rise to drag at the small texture length scale. The portions of the texture peaks 9 above the water meniscus 8 force the fluid in a boundary layer 4 and 5 to accelerate around the roughness features or peaks 9 which counteracts the benefits of reduced skin friction drag due to the trapped air pockets 7. Thus, it is desirable to minimize the portion of individual texture peaks 9 above the water meniscus 8. Quantifying, measuring and controlling the exact portion of individual texture peaks 9 above the water meniscus 8 is a difficult task. Nonetheless, since the portion of individual texture peaks 9 above the water meniscus 8 scales with the average surface roughness Ra, the use of textures with a relatively small average surface roughness as depicted in FIG. 2B reduces the portion of individual asperity peaks penetrating into meniscus 8. Specifically, use of textures with average surface roughness smaller than or equal to about 1/10^{th} of the local thickness of the viscous sub-layer 4 of the fluid boundary layer 4 and 5 (see below), reduces or eliminates unwanted fluid drag. The calculation of the thickness of the viscous sub layer 4 needed to calculate the appropriate surface roughness Ra limit is presented below.

Those skilled in the art will appreciate that local fluid flow properties (such as density, viscosity) and the flow conditions (mean fluid velocity) may be used to calculate a local non-dimensional Reynolds number (Re). One can use this local Reynolds number along with correlations for local skin-friction fluid drag coefficient for smooth, non-textured surfaces (that are based on turbulent boundary layer theory for a given flow geometry) to calculate local thickness of the viscous sub-layer 4. Specifically, since the local thickness of the viscous sub-layer is 5 non-dimensional wall units, a dimensional value for the thickness (y) of the viscous sub-layer is calculated as:

b=5υ/{square root over ((τ(Re)/ρ))}

where (υ) is the fluid kinematic viscosity, (τ) is the local shear stress dependent on the local Reynolds number (Re) and (ρ) is the fluid density. Upon calculation of the viscous sub layer thickness (y), an average surface roughness Ra smaller than or equal to y/10 (that is, up to about 10% of the viscous sub layer thickness) can be chosen for the texture. As shown in FIG. 2B, choosing an appropriately small surface roughness ensures that the portion of individual texture peaks 13 above the water meniscus 12 is a small fraction of the viscous sub-layer 4; unlike FIG. 2A where a large surface roughness causes the portion of individual texture peaks 9 above the water meniscus 8 to be significant fraction of the viscous sub-layer 4. The present inventors have found that using textures with a small surface roughness compared to the local viscous sub-layer thickness is an effective method for fluid drag reduction, even in turbulent flow regime--a result hitherto unknown for randomly textured hydrophobic surfaces and turbulent flow regimes for external flow configurations like vessel hulls and internal flow configurations like flow through a pipe. Another relevant factor is the porosity of the textured surface, defined as the ratio of void volume of the textured surface coating, which can be occupied by air and excludes the solid substance that constitutes that coating, to the total volume of the textured surface, including void volume and the solid component of the textured surface. Increased porosity allows increased amounts of air to be retained at the interface between the coated surface and a liquid, further promoting the formation and prolonging the duration of Cassie state.

Further, applying a material to reduce surface energy enhances the effects of low asperity spacing, low roughness, and high porosity in reducing fluid drag. For example, applying a material that reduces surface energy, such as polytetrafluoroethylene or fluorosilane, to the appropriately textured coating on a solid surface reduces fluid drag across it under laminar and turbulent fluid flow conditions. Applying a material to reduce surface energy is expected to reduce the inherent porosity of the underlying texture because the low surface energy coating goes and fills up some of the voids. For surface energy-reducing materials like polytetrafluoroethylene or fluorosilane, the material layer thickness is very small compared to the characteristic dimensions of the porosity voids, resulting in a very small change in the inherent porosity of the texture. Nonetheless, the term porosity herein refers to the final resultant porosity attained after applying a low surface energy material to the underlying texture.

Thus, the present inventors have created a method by which drag caused by a fluid flowing over a solid surface and a viscous sub-layer of the fluid contacting the surface is decreased when the surface has a coating with asperities whose average spacing is between about 0.01 and 1.5 micron, the coating's average surface roughness is about 10% of the thickness of the viscous sub-layer, and average porosity of the coating is in the range of about 35% to about 60%, when a material to reduce surface energy is disposed on the coating so as to contact the fluid as it flows over the surface. Also, a method for creating an article with such a textured coating and reduced surface energy is provided. The method includes the steps of feeding a feedstock into a thermal spray torch, applying the feedstock on a substrate surface to form a textured coating on the surface, and applying on the textured surface a material to reduce surface energy to form a hydrophobic or a superhydrophobic coating. Also provided is a surface that is resistant to fluid drag because it has a textured coating and a material to reduce surface energy applied thereon according to an embodiment of the present invention, and a method for reducing drag of a fluid flowing over a surface upon which a textured coating and a material for reducing surface energy has been applied. An average surface roughness of such a coating in accordance with the invention may be up to about 2 microns.

In a copending application for U.S. patent entitled METHODS OF COATING A SURFACE AND ARTICLES WITH COATED SURFACE, U.S. patent application Ser. No. 13/723,301, a method for applying a hydrophobic textured coating to a solid surface and a material to reduce surface energy to a textured coating is disclosed, which method can be performed in accordance with the techniques and articles described herein. In one example, a coating is applied to a solid surface by thermal spraying onto the surface a feedstock composed of a particle precursor, or particles disposed in a liquid carrier. The particles may include an organic or inorganic material, a ceramic, a metal, a polymer, or any combination thereof. By varying the type, size, and concentrations of particles in the feedstock, the characteristics of the resulting textured coating may be varied. Variations in liquid carrier used in the feedstock, and in thermal spray processing parameters, such as stand-off distance and duration of thermal spraying, may also lead to variations in the resulting textured coating.

As used herein, the term “derived from feedstock” means that one or more particles are obtained from a liquid feedstock. In one embodiment, the feedstock is a particle precursor which decomposes during the spray process to form particles which are deposited on the surface. For example, the liquid is pyrolized to form particles that are deposited and form a textured coating with fine particles. In another embodiment the liquid feedstock is a suspension of particles in a liquid which releases the particles during the spray process upon evaporation of the liquid to deposit particles on the surface. The term “derived from” is used herein to refer to both of these cases. In another embodiment, the liquid feedstock is a combination of a particle precursor and a suspension.

The term “low surface energy material” as used herein means a material with surface energy less than about 35 mJ/m² and typically exhibits hydrophobic behavior. Materials having surface energy less than about 20 mJ/m² are highly hydrophobic and exhibit contact angles with water greater than 90 degrees. Non-limiting examples of low surface energy materials are polytetrafluoroethylene (PTFE), polydimethylsiloxane PDMS, paraffin wax, polypropylene, octadecyltrichlorosilane, polyethylene, polystyrene, and fluoroalkysilanes.

Examples of a method of coating a surface are disclosed, wherein the method includes feeding a feedstock to a thermal spray torch, the feedstock including a liquid, disposing the feedstock on a substrate by thermal spray under conditions selected to produce a textured surface, wherein the textured surface includes randomly distributed agglomerations of at least partially melted and solidified particles derived from the feedstock with individual at least partially melted and solidified particles derived from the feedstock disposed on a surface of the agglomerations, and applying over the textured surface a material to reduce surface energy.

The textured surface may include one or more elevations, depressions or both. The elevations may include agglomerations of at least partially melted and solidified particles. “At least partially melted” as used herein means material at least a portion of which had melted during spray processing. The term also includes material that was completely molten at some point in the process.

The particles of the feedstock may include an organic material or an inorganic material. In some embodiments, the feedstock includes particles made of a ceramic, a metal, a polymer or combinations thereof In one embodiment, the particles of the feedstock include ceramic materials. The ceramic particles may constitute a first layer of coating on a surface by a thermal spray deposition. In some embodiments, the ceramic material constituting the surface includes, but is not limited to, an oxide, a mixed oxide, a nitride, a boride, a carbide or combinations thereof. The feedstock may include ceramic particles including zirconium oxide, aluminum oxide, titanium oxide, yttrium oxide, ytterbium oxide, silicon oxide, cerium oxide, lanthanum oxide, or any of the combinations. Non limiting examples of suitable ceramics may include carbides of silicon or tungsten; nitrides of boron, titanium, silicon. In some embodiments of the method, the ceramic material includes yttria stabilized zirconia (YSZ), yttrium aluminum garnet (Y₃Al₅O₁₂ or YAG), ytterbium oxide (Yb₂O₃), lanthanum cerate, or combinations thereof.

In accordance with one aspect of the invention, feedstock forms a coating on the substrate surface by a thermal spray technique under specific conditions, as described above. The thermal spray method may include flame spray, HVOF, HVAF, arc spray, cold spray or plasma spray, or any other thermal spray method, or methods that allow at least partial melting of the feedstock Several processing parameters may affect the nature of the texture in a resultant coating. The feedstock injection, the characteristics of the suspension, the particle size distribution, the characteristics of the suspended particles, the plasma parameters such as power and gas flow rate, the stand-off distance between the plasma torch and surface, and the torch motion are significant operating parameters among the major extrinsic parameters for suspension plasma spray process to be considered. For example, an injection of a liquid stream may reduce the perturbation of the plasma flow and may permit a homogeneous treatment of the suspension within the plasma jet.

The characteristics of the suspension may be significant. For example, ethanol as liquid carrier is advantageous compared to de-ionized water for consuming less energy of vaporization. The particle size distribution may also be significant as the size distribution has an effect on the architecture of the coating, such as distribution of agglomerations or pore-structure. For example, a narrow particle size distribution may promote dense coatings whereas broad particle size distributions may promote porous coatings. The plasma torch power may be significant, as, for example, a higher plasma torch power may permit a higher degree of particle melting. The plasma gas flow rate may be significant. For example, a high plasma gas flow rate may permit higher particle velocity, which may result in a texture different than the one obtained with lower particle velocity. The stand-off distance between the torch and the surface may be significant. For example, a short stand-off distance between the spray gun and the substrate increases the thermal transfer to the substrate and in turn modifies the coating architecture.

The invention further includes applying to the textured surface a material to reduce surface energy. Such material may be applied by spin coating, dip coating, brush painting, or spray coating to coat a surface or any method known in the art for applying such materials. In some embodiments, the material is a low surface energy material wherein the material has a surface energy less than about 35 mJ/m² and typically exhibits hydrophobic behavior. Materials having surface energy less than about 20 mJ/m² are highly hydrophobic and exhibit contact angles with water greater than about 90 degrees. Non-limiting examples of low surface energy materials are polytetrafluoroethylene PTFE, polydimethylsiloxane PDMS, paraffin wax, polypropylene, octadecyltrichlorosilane, polyethylene, polystyrene, and fluoroalkysilanes. Application of a low surface energy material may render the textured surface superhydrophobic.

As noted, a low surface energy material is disposed on a textured surface, and produces a hydrophobic coating, or a superhydrophobic coating. In some embodiments, the coating develops a contact angle of at least about 90° between the coated surface and a static drop of water disposed on the coated surface. In some other embodiments, a hydrophobic coating has a sufficient hydrophobicity to develop a contact angle of at least about 130° between the coated surface and a static drop of water disposed on the coated surface. In some other embodiments, a hydrophobic coating has a sufficient hydrophobicity to develop a contact angle of at least about 150° between the coated surface and a static drop of water disposed on the coated surface.

The low surface energy material, in some embodiments, includes an inorganic material, a fluorinated material, a polymer, or combinations thereof. The low surface energy material may include a material that is selected from the group consisting of DLC, fluorinated DLC, chromium nitride, titanium nitride, zirconium nitride, hafnium carbide, chromium carbinde, titanium carbide, zirconium carbide, hafnium carbide, lanthanum cerate, neodymium cerate, praseodymium cerate, ytterbium oxide, cerium-doped yttrium aluminum garnet, nickel, cobalt, and combinations thereof.

In one embodiment, the low surface energy material may include fluorinated material. The fluorinated material may include a fluorosilane or a fluoroalkylsilane. In some embodiments, the polymer includes at least one selected from the group consisting of silicones, fluoropolymers, urethanes, acrylates, epoxies, polysilazanes, aliphatic hydrocarbons, polyimides, polycarbonates, polyether imides, polystyrenes, polyolefins, polypropylenes, polyethylenes and combinations thereof. In some embodiments, the low surface energy material includes fluoropolymers, siloxanes, silane, alkyl silane, fluorosilane, fluoro alkyl silane or combinations thereof.

Non-limiting examples of a fluoro-alkylsilane includes tridecafluoro 1,1,2,2-tetrahydrofluoro octyl trichlorosilane, and heptadecafluoro-1,1,2,2-tetrahydrodecyl trimethoxysilane (also known as FAS). The number of fluorine atoms present and the length of the polymeric back bone chain of the fluorosilane may play a role in the effective hydrophobicity of the coating formed by the fluorosilane solution. FAS has 17 fluorine atoms present in the compound formula that imparts a high hydrophobicity to the applied coating. In one embodiment, the surface energy-reducing material includes a solvent and a fluorosilane. In another embodiment, the surface energy-reducing material includes PTFE.

As used herein, the term “surface” is not construed to be limited to any shape or size, as it may be a layer of material, multiple layers or a block having at least one surface of which the wetting resistance is to be modified. In one embodiment, the surface is an inner surface of a pipe. In some embodiments, it is beneficial to have a pipe whose interior surface is resistant to fluid drag, such that less energy is required to propel water through the interior of the pipe, whether under laminar or turbulent flow conditions. In another embodiment, the surface is an outer surface of a vessel hull that may be fully immersed in water and which surface is resistant to fluid drag such that less energy is required to propel the vessel through water, whether under laminar or turbulent flow conditions.

The following examples illustrate methods, materials and results, in accordance with specific embodiments, and as such should not be construed as imposing limitations upon the claims.

In one example for thermal spray coating, feedstock was prepared by suspending a plurality of ceramic particles in a solvent. The suspension was wet milled to achieve the desired particle size distribution, and further diluted with more solvent to achieve desired solid particle concentration. Up to 0.1 weight % of polyethyleneimine was added to stabilize the suspension. The ceramic materials used herein were Yttria (8 weight %)-stabilized Zirconia, referred to herein as 8YSZ, and Yttria (13 weight %)-stabilized Zirconia, referred to herein as 13YSZ. Ethyl alcohol, denatured was used herein as a solvent. The concentration of solid particles in the suspension was between about 10 to about 20 wt %.

Different materials were used for developing textured surface by suspension plasma spray (SPS), wherein the concentration of the precursor material was different. The particle distribution of the precursor material was also different, as shown in Table 1.

TABLE 1
The particle distribution of the feedstock material

| | | Solid | Particle size | | |
|---|---|---|---|---|---|
| Feedstock | | particle | distribution | | |
| Identification | Material | conc. (wt %) | D₁₀ (μm) | D₅₀ (μm) | D₉₀ (μm) |
| 8Y | 8YSZ | 20 | 0.59 | 1.82 | 3.4 |
| 13Y | 13YSZ | 10 | 0.34 | 0.58 | 1.36 |

The feedstock was fed into a thermal spray torch and was applied on a solid surface. The precursor material (feedstock) was applied using suspension plasma spraying (SPS). SPS was carried out based on two plasma guns: the Axial III gun and the 9 MB gun (Sulzer Metco AG, Wohlen, Switzerland). Feedstock injection was axial for the Axial III gun, and radial for the 9 MB gun. The axial injection means injecting the feedstock material along the axis of the plasma plume. The radial injection means injecting the feedstock material across the axis of the plasma plume, the injection angle being within about 60 degrees of the normal of the axis of the plasma plume. In the examples described below where radial injection was used, the injection was normal to the axis of the plasma plume. Different gun parameters were optimized and used for SPS. A “stand-off” distance, that is the distance between the nozzle of the torch and the substrate-surface to be coated, was also optimized per application requirement. Stand-off distances were between about 3.5 cm and about 10 cm. The precursor material was applied using the torch under various conditions. In one embodiment, 13YSZ feedstock was applied by radial injection at 41.1 kW, with a standoff distance of 6.4 cm. Resultant coatings possess a random distribution of asperities.

In another example, a low surface energy material was applied to the textured coating. The materials used for coating were fluorosilane and PTFE. To apply a coating of fluorosilane, a vacuum desiccator with a polymer shell was used, which has adequate size to hold at least 10-15 samples.

A desiccator was set up with a petri dish centered on its floor. 1 ml of FAS solution was carefully pipetted out and added into the petri dish. The samples were arranged in the desiccator such that the surface to be treated was facing up. A vacuum source was used to achieve lower than 30 inHg pressure. The vacuum source was removed after reaching the desired pressure inside the desiccator and ensured that the desiccator remained sealed. The sample was dried under vacuum for 8 to 24 hrs. In one example, the sample was dried for 18 hrs in desiccator under vacuum condition.

PTFE (Teflon AF powder) was used for some of the experiments. Dried PTFE powder was dissolved in perfluorinated solvents, such as FC 72. The dissolution time ranged from a few hours to a few days. The PTFE liquid film was then brush painted onto the target surface. After application of the PTFE film on the surface, the surface was then heated above the glass transition temperature of the PTFE and the boiling point of the solvent, typically between about 175-300° C., for about 15-20 minutes. This heat treatment removed the solvent and produced a PTFE film coated on the surface. The thickness of the film varied and depended on the application technique and the concentration of PTFE in the initial solution.

Friction drag coefficients for water flowing across coated and non-coated surfaces were measured with a water tunnel with Reynolds numbers up to about 9 x 10⁶ by methods known to those skilled in the art of fluid flow dynamics. Direct shear stress (skin friction drag) measurements were thereby taken on test samples under conditions of turbulent fluid flow. Roughness (Ra) and asperity spacing of coated surfaces were measured by optical profilometry and scanning electron microscopy (SEM) respectively according to standard methods that would be known by one skilled in the art of surface geometry. Contact angles for various samples were measured using a goniometer with standard methods that would be known by one skilled in the art.

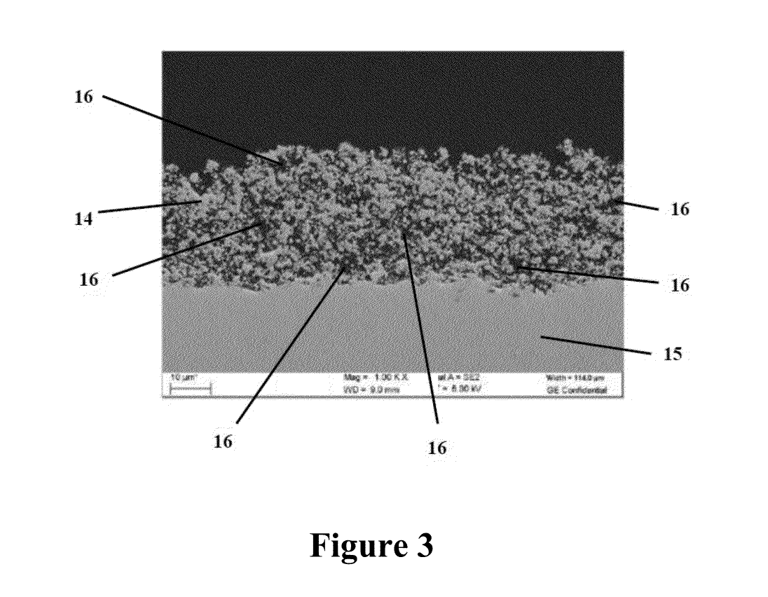

To measure porosity of textured coatings, a coated surface was infiltrated and covered with an epoxy which was allowed to harden. A cross-sectional cut was then made through the epoxied surface. The epoxy served to maintain integrity of surface geometry during and after cutting. The cross-section was viewed under a SEM at 1,000-times magnification and rendered as a digital image. An example of such an image is shown in FIG. 3, reference to which will aid in understanding how porosity was measured. In FIG. 3, grey coloration signifies solid components of the textured coating 14 and the solid surface to which it had been applied 15. Imaginary lines were drawn approximating the top boundary of the textured coating 14 and the bottom boundary between the textured coating 14 and the solid surface 15. The area of the imaged region between those lines was taken as the measure of the total volume of the textured coating 14.

The area per image representing void volume was determined by measuring the black areas within the textured coating 14, which represent air pockets 16 between the solid portions of the textured coating. Some examples of air pockets 16 are identified in FIG. 3 for illustrative purposes, but it should be understood that the total sum of all black areas within the boundaries of the textured coating 14 was taken as the area per image representing void volume, not just of the air pockets 16 that are specifically identified in FIG. 3. A relative measure of porosity was then calculated by dividing the area per image representing void volume by the area per image representing the total volume of the textured coating 14. Furthermore, the values of porosity calculated and reported here were obtained by averaging the calculated porosity across four to five such SEM images at identical magnification levels.

A summary of samples tested in a water tunnel is provided below in Table 2.

TABLE 2
Summary of samples tested in water-tunnel for drag reduction

| | | | | Pre- | | |
|---|---|---|---|---|---|---|
| | | | Average | dicted | | |
| | | Low | Measured | wetted | Surface | |
| Sample | | surface | Contact | area | Roughness | Porosity |
| Identifi- | Texture | energy | Angle (θ) | fraction | (Ra) | (% |
| cation | Material | coating | (degrees) | (f) | (microns) | volume) |
| Baseline | No | None | — | 1 | 0.69 | 0 |
| | texture, | | | | | |
| | smooth | | | | | |
| | steel | | | | | |
| | plate | | | | | |
| Plate 2 | 13YSZ | None | — | More | 1.2 | 54 |
| | | | | than 1 | | |
| Plate 6 | 8YSZ | FAS | 150 | 0.16 | 8.4 to 12.8 | 17 |
| Plate 11 | 13YSZ | FAS | 154 | 0.14 | 1.2 | 57 |
| Plate 12 | 13YSZ | PTFE | 155 | 0.19 | 1.1 | 46 |

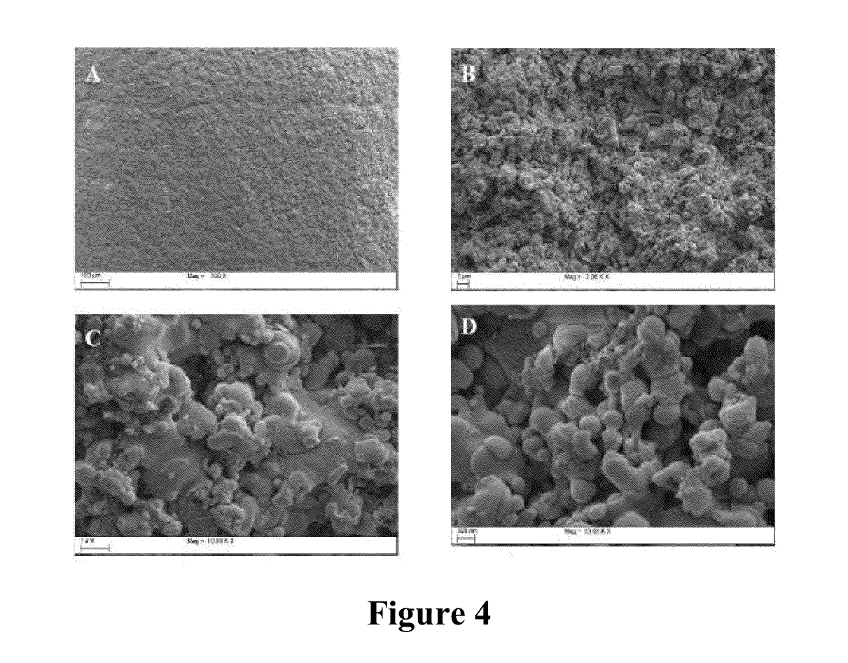

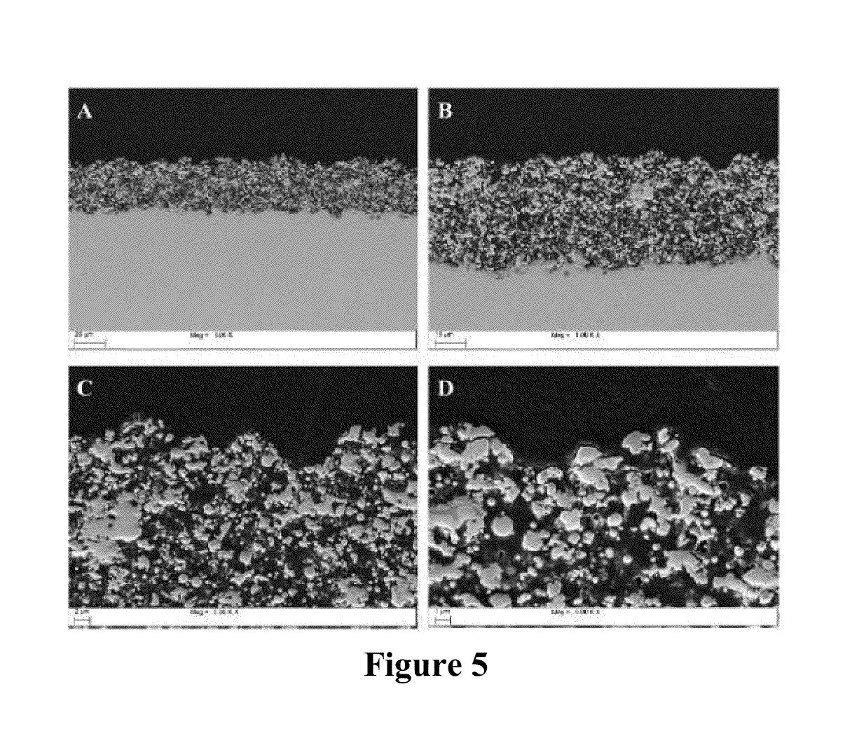

FIGS. 4A-D are SEM images of a coating consisting of 13YSZ, as listed in Table 1 and Table 2, taken at different magnifications (100-times, 2,000-times, 10,000-times, and 20,000-times, respectively). Feedstock was processed using SPS by radial injection, at 40.3 kW power and a stand-off distance of 6.4 cm. The resultant textured coating was further coated with FAS as described. FIGS. 5A-D are SEM images of cross sections of this coating at different magnifications (500-times, 1,000-times, 2,500-times, and 5,000-times, respectively). The textured coating shown in FIGS. 4A-D and FIGS. 5A-D, referred to as Plate 11, had an asperity spacing of about 1.3 micron or smaller, an average Ra value of approximately 1.2 microns, a measured contact angle of about 154°, a predicted wetted area fraction about 0.14 and high porosity of about 57%.

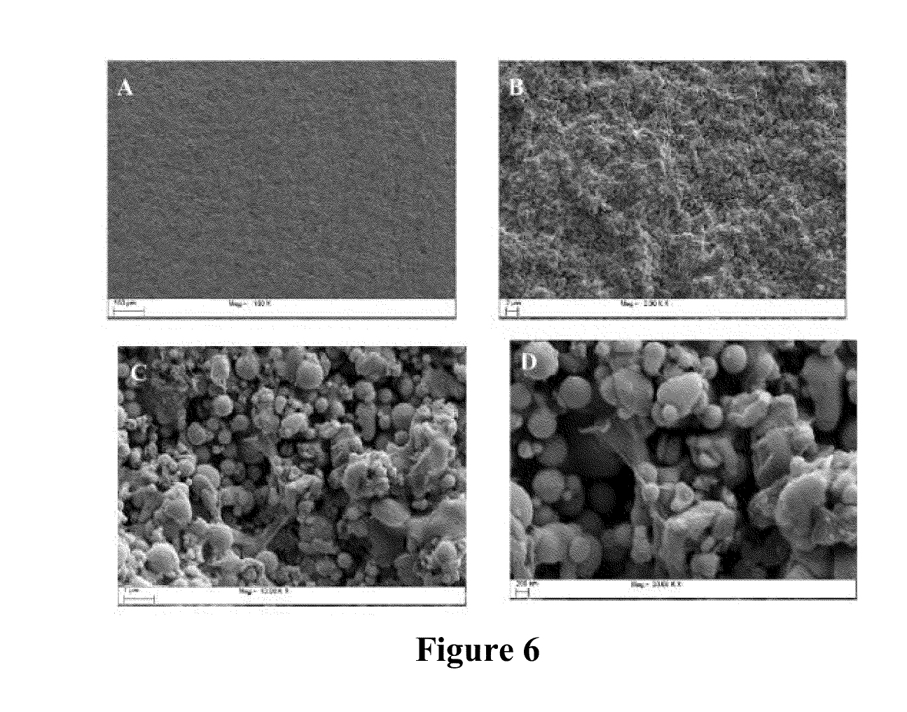

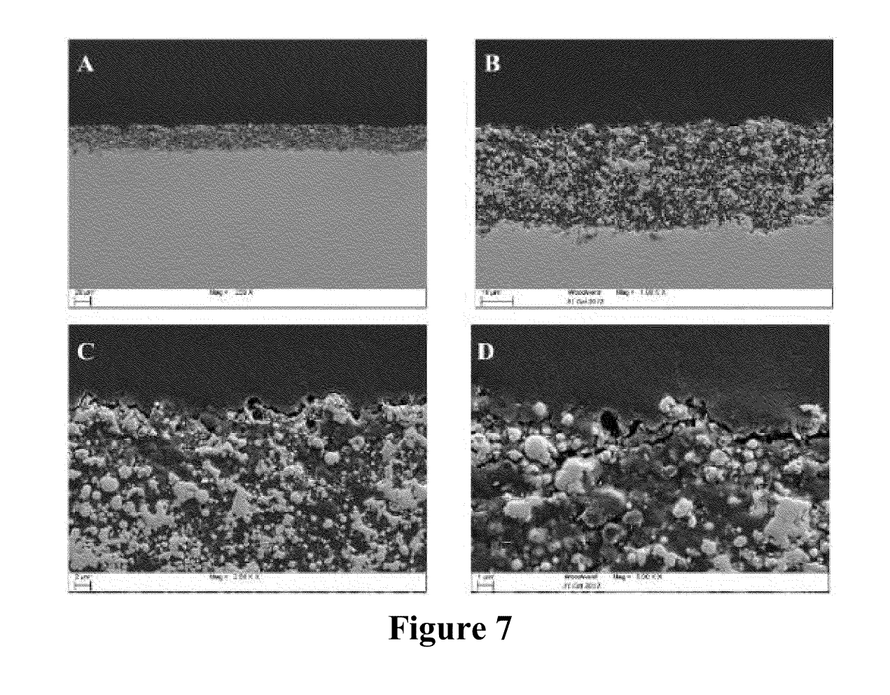

FIGS. 6A-D are SEM images of a coating consisting of 13YSZ, as listed in Table 1 and Table 2, taken at different magnifications (100-times, 2,000-times, 10,000-times, and 20,000-times, respectively) Feedstock was applied using SPS by radial injection, at 41.1 kW power and a stand-off distance of 6.4 cm. The textured coating was further coated with PTFE as described. FIGS. 7A-D are SEM images of cross sections of this coating at different magnifications (250-times, 1,000-times, 2,500-times, and 5,000-times, respectively). The textured coating shown in FIGS. 6A-D and FIGS. 7A-D, referred to as Plate 12, had an asperity spacing of about 1.2 micron or smaller, an average Ra value of about 1.1 microns, a measured contact angle of about 155°, a predicted wetted area fraction about 0.19 and high porosity of about 46%.

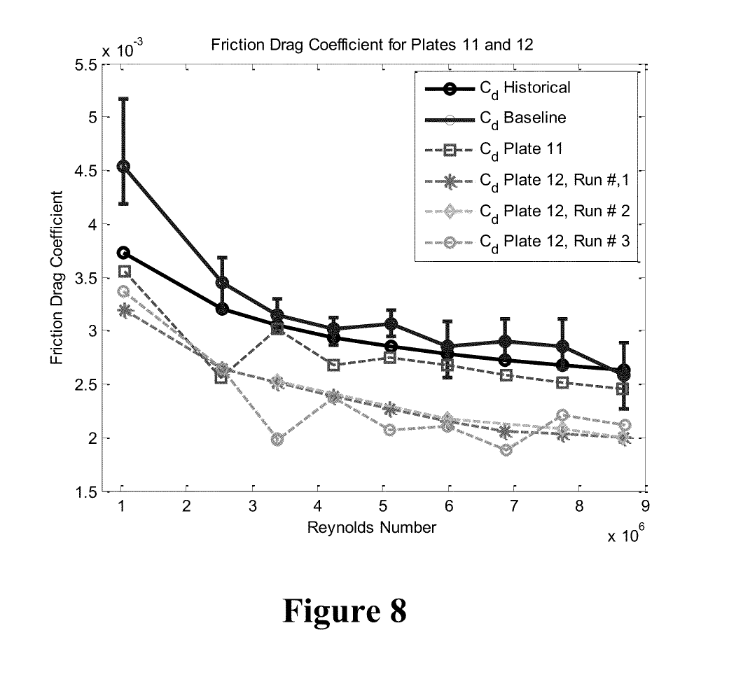

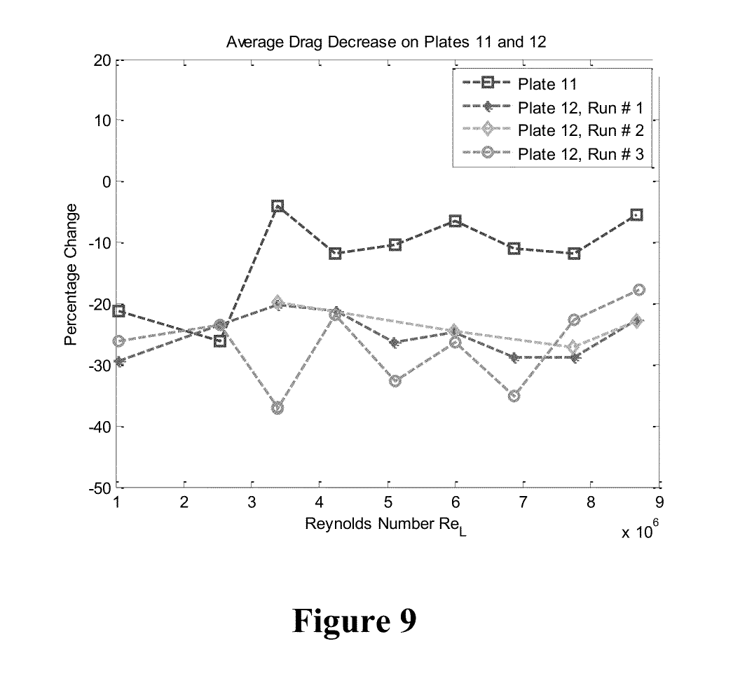

FIG. 8 is a line graph showing friction drag coefficients (C_{d}), as shown on the Y axis, for different samples, tested under turbulent flow conditions, as shown on the X axis. One non-coated sample was tested (Baseline) as were two coated samples (Plate 11 and Plate 12). Also plotted is a line graph (Historical) for turbulent drag coefficients for a flat smooth plate, which is historical data-based turbulent drag correlation reported in a textbook (Viscous Fluid Flow, F. M. White, 1991, McGraw-Hill Inc.). Measurements of Plate 12 were taken three times (Runs #1, #2, and #3) to establish repeatability with the same set-up and repeatability after a complete disassembly-reassembly of the set-up across different Reynolds numbers. FIG. 9 is a line graph showing the difference of friction drag coefficients between coated and noncoated samples, measured as the percentage of change in the average drag coefficient for coated samples compared to uncoated, as shown on the Y axis. Again, coated Plate 12 was measured three separate times. As can be seen, coated samples Plate 11 and Plate 12 showed a reduction in fluid drag at smaller Reynolds numbers. At higher Reynolds numbers, including levels indicative of turbulent fluid flow conditions, the fluid drag coefficient of Plate 11 was relatively unchanged from that of uncoated samples, but the fluid drag coefficient of Plate 12 remained about 20% to about 30% reduced compared to baseline at all levels of fluid flow.

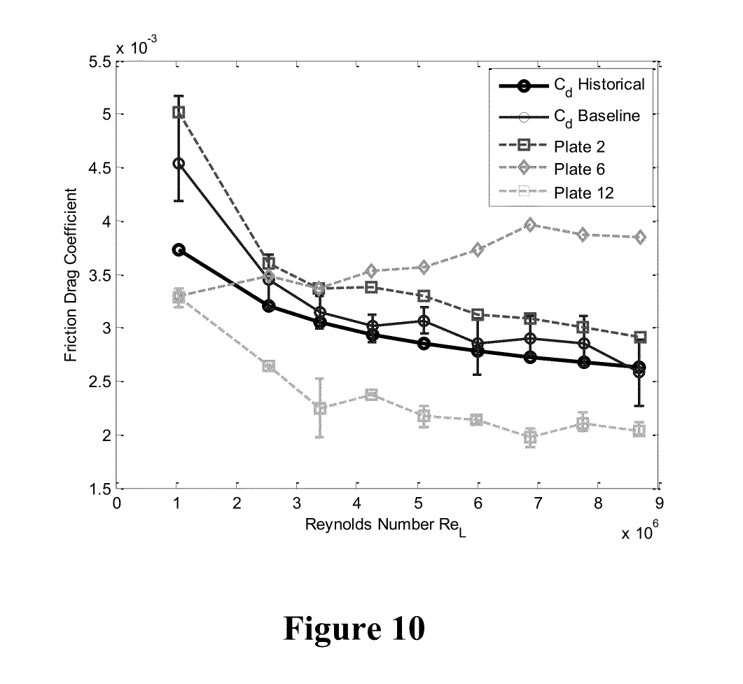

FIG. 10 is a line graph showing friction drag coefficients (C_{d}), as shown on the Y axis, for different samples, tested under turbulent flow conditions, as shown on the X axis. Non-coated samples were tested (Baseline) as were several coated samples, including Plates 2, 6 and Plate 12. The textured coating of Plate 6 was 8YSZ as listed in Table 1 and Table 2. Feedstock was applied using SPS by axial injection at 92.8 kW power and a stand-off distance of 8.9 cm. Plate 6 also had a layer of FAS applied to the textured coating. Plate 6 had an asperity spacing of about 15.9 microns or smaller, an average Ra value of approximately 8.4 to 12.8 microns, a measured contact angle of about 150°, a predicted wetted area fraction about 0.16 and low porosity of about 17%. The textured coating of Plate 2 was 13YSZ as listed in Table 1 and Table 2. Feedstock was processed using SPS by radial injection at 43.1 kW power and a stand-off distance of 5.1cm. No layer of surface energy modification material was applied to the resultant textured coating of Plate 2. Plate 2 had an average Ra value of approximately 1.2 microns and a porosity of about 54%.

For the water-tunnel flow conditions, with Reynolds number increasing from 1×10⁶ to 9×10⁶, the predicted local thickness of the viscous sub-layer decreased from about 94 microns to about 13 microns. These predictions for the local thickness of the viscous sub-layer are based on the smooth, flat plate turbulent boundary layer drag correlations reported in a textbook (Viscous Fluid Flow, F. M. White, 1991, McGraw-Hill Inc.) As already discussed, Plate 12 showed up to about 20% to about 30% reduction in fluid drag coefficient compared to the noncoated sample under conditions of turbulent fluid flow. This behavior of Plate 12 is attributed to the sustained presence of Cassie state and its small Ra value of 1.1 microns compared to the thickness of the viscous sub-layer ranging from about 94 microns to about 13 microns. Plate 11 also shows moderate drag reduction at low Reynolds numbers, with drag reduction disappearing at higher Reynolds numbers. This difference in behavior between Plate 12 and 11 is attributed to the difference in their respective low surface energy coatings. Despite possessing hydrophobicity (as shown through the measured contact angle), Plate 6 showed more than an about 45% increase in fluid drag coefficient compared to noncoated samples, particularly as Reynolds number increased. This behavior of Plate 6 is attributed to its relatively large Ra value of about 8.4 to 12.8 microns when compared to the thickness of the viscous sub-layer ranging from about 94 microns to about 13 microns, especially so at higher Reynolds numbers. Also, Plate 2 showed overall higher fluid drag than uncoated samples. This higher drag measured in Plate 2 can be attributed to the absence of surface energy modifying layer on the texture, thereby causing the absence of Cassie state.

Together, these surprising results demonstrate that increasing hydrophobicity, by applying a low surface energy material on a textured surface and creating a Cassie state on its own does not necessarily decrease fluid drag. Rather, such conditions may exhibit a significantly reduced fluid drag across laminar and turbulent fluid flow conditions when accompanied by the levels of porosity and low surface roughness compared to the local viscous sub-layer as described above, for example in reference to Plate 12.

Examples of solid surfaces with textured coatings having the combined characteristics of low asperity spacing of between about 0.01 and about 1.5 micron, low average roughness of about 2 microns or less, and average porosity of about 35% to about 60%, when further coated with PTFE, exhibited especially robust resistance to fluid drag. A method for decreasing fluid drag across the solid surface of an article may thus be performed by applying a coating with such characteristics to the surface and a material for reducing surface energy, and contacting the coated surface with a local viscous sublayer of a flowing fluid.

Generally, conventional surfaces show an absence of significant drag reduction in the turbulent flow regime especially in instances where the average surface roughness was comparable to the predicted local viscous sub-layer thickness for the respective fluid flow geometries and fluid flow conditions. In light of the data available in the existing literature, the new findings presented herein demonstrate the importance for fluid drag reduction of small surface roughness of a textured coating applied to a surface relative to the local viscous fluid sub-layer thickness.

It should be appreciated by those with experience in this field that there are means of attaining surface geometry characteristics in accordance with the invention claimed herein other than as described in the above embodiments. For example, although the preferred embodiment of thermal spraying is described above, other methods in accordance with the invention claimed herein may also be used to create a textured surface with characteristics that reduce fluid drag as described above, such as sintering, lithography, machining, powder consolidation, or chemical/physical vapor deposition. Furthermore, where thermal spraying is used in accordance with the present invention, feedstocks with different types, sizes, and concentrations particles, and different types of liquid carriers, can also be used, and variations on thermal spraying technique can also be employed, all in accordance with embodiments of the present invention. Any method for applying to a solid surface a textured coating with the geometrical and drag-resistant properties disclosed herein, and any solid surface with such a coating, is in accordance with the invention described herein.

1. An article comprising:
a substrate;
a coating disposed on the substrate, the coating comprising a plurality of asperities, wherein the coating has an average spacing between asperities in the range from about 0.01 micron to about 1.5 micron, an average surface roughness of up to about 2 microns, and an average porosity in the range from about 35% to about 70%; and a material to reduce surface energy is disposed on the coating.

2. The article of claim 1, wherein the coating comprises a ceramic, a metal, a polymer, or a combination thereof.

3. The article of claim 2, wherein the ceramic comprises yttria-stabilized zirconia (YSZ), yttrium aluminum garnet (Y₃Al₅O₁₂ or YAG), ytterbium oxide (Yb₂O₃), or a combination thereof.

4. The article of claim 1, wherein the material to reduce surface energy is a low surface energy material.

5. The article of claim 4, wherein the low surface energy material comprises an inorganic material, a fluorinated material, a polymer, or a combination thereof.

6. The article of claim 5, wherein the fluorinated material comprises a fluorosilane, a fluoroalkylsilane, a fluoropolymer, or a combination thereof.

7. The article of claim 1, wherein the average surface roughness of the coating is up to about 1.5 microns.

8. The article of claim 2, wherein the substrate is an inner surface of a pipe, or a surface of a vessel hull.

9. A method for making an article, comprising:
disposing a coating on a substrate, the coating comprising a plurality of asperities, wherein the coating has an average spacing between asperities in the range from about 0.01 micron to about 1.5 micron, an average surface roughness of up to about 2 microns, and an average porosity in the range from about 35% to about 70%; and disposing on the coating a material to reduce surface energy.

10. The method of claim 9, wherein disposing the coating comprises:
feeding a feedstock to a thermal spray torch, the feedstock comprising a liquid carrier and a plurality of particles disposed in the liquid;
disposing on the surface by thermal spray a plurality of agglomerations of at least partially melted and solidified particles derived from the feedstock with individual at least partially melted and solidified particles derived from the feedstock disposed on a surface of the plurality of agglomerations.

11. The method of claim 10, wherein the feedstock comprises a ceramic, a metal, a polymer, or a combination thereof

12. The method of claim 11, wherein the ceramic comprises at least one of yttria-stabilized zirconia (YSZ), yttrium aluminum garnet (Y₃Al₅O₁₂ or YAG), ytterbium oxide (Yb₂O₃), or a combination thereof.

13. The method of claim 10, wherein the agglomerations further comprise fully melted and re-solidified particles.

14. The method of claim 9, wherein the material to reduce surface energy is a low surface energy material.

15. The method of claim 14, wherein the low surface energy material comprises an inorganic material, a fluorinated material, a polymer, or a combination thereof.

16. The method of claim 15, wherein the low surface energy material comprises a fluorosilane, a fluoroalkylsilane, a fluoropolymer, or a combination thereof.

17. The method of claim 10, wherein a concentration of the particles disposed in the liquid carrier is up to about 40 wt %.

18. The method of claim 9, wherein the average surface roughness of the coating on the surface is up to about 1.5 microns.

19. A method for decreasing fluid drag across a solid surface comprising:
causing a fluid to flow over the surface of an article such that a local viscous sub-layer of the fluid is in contact with the surface, wherein the article comprises
a substrate,
a coating disposed on the substrate, the coating comprising a plurality of asperities, wherein the coating has an average spacing between asperities in the range from about 0.01 micron to about 1.5 micron, an average surface roughness of up to about 10% of the thickness of the local viscous sub-layer, and an average porosity in the range from about 35% to about 70%, and
a material to reduce surface energy disposed on the coating,
wherein the material to reduce surface energy is disposed to contact the fluid as the fluid flows over the surface of the article.

20. The article of claim 19, wherein the coating comprises a ceramic, a metal, a polymer, or a combination thereof

21. The article of claim 20, wherein the ceramic comprises yttria-stabilized zirconia (YSZ), yttrium aluminum garnet (Y₃Al₅O₁₂ or YAG), ytterbium oxide (Yb₂O₃), or a combination thereof.

22. The article of claim 19, wherein the surface energy modification material is a low surface energy material.

23. The article of claim 22, wherein the low surface energy material comprises an inorganic material, a fluorinated material, a polymer, or a combination thereof.

24. The article of claim 23, wherein the fluorinated material comprises a fluorosilane, a fluoroalkylsilane, a fluoropolymer, or a combination thereof.

25. The article of claim 19, wherein the average surface roughness of the coating is up to about 1.5 microns.

26. The article of claim 20, wherein the substrate is an inner surface of a pipe, or a surface of a vessel hull.
